(19) United States
(12) Patent Application Publication
(10) Pub. No.: US 2009/0224724 A1
(43) Pub. Date: Sep. 10, 2009

(54) APPARATUS FOR CHARGING AN ELECTRIC POWERED VEHICLE AND PAN METHOD USING THE SAME

(75) Inventors: Jinsuk MA, Daejeon (KR); Sunja KIM, Daejeon (KR)

Correspondence Address: AMPACC LAW GROUP, 3500 188th St. SW, Lynnwood, WA, 98037, US

(73) Assignee: Electronics and Telecommunications Research Institute, Daejeon (KR)

(21) Appl. No.: 12/351,779

(22) Filed: Jan. 9, 2009

(30) Foreign Application Priority Data
Mar. 5, 2008 (KR) 10-2008-0020465

(51) Int. Cl. H02J 7/00

(52) U.S. Cl. 320/109

(57) ABSTRACT

The present invention provides an apparatus for charging an electric powered vehicle. The apparatus includes a vehicle charging connector; an electrical power storage unit that is connected to the vehicle charging connector, receives electricity from the outside through a powerline, and stores the electricity; and a PAN (powerline area network) modem that is connected to the vehicle charging connector, connects the powerline with the vehicle information terminal, and transmits a data signal. Accordingly, it is possible to overcome potential noise of a powerline, high load interference, data signal distortion, and the like that occur when a data signal is transmitted while charging a vehicle by a PLC technique in the related art, and to allow a user to effectively and reliably transmit a data signal to a vehicle information terminal through a powerline while charging a vehicle.

### RELATED APPLICATIONS

The present application claims priority to Korean Patent Application Serial Number 10-2008-0020465, filed on Mar. 5, 2008, the entirety of which is hereby incorporated by reference.

### BACKGROUND OF THE INVENTION

1. Field of the Invention

The present invention relates to an apparatus for charging an electric powered vehicle, and more particularly, to a PAN (powerline area network) method using an apparatus for charging an electric powered vehicle, and the apparatus for charging an electric powered vehicle.

This work was supported by the IT R&D program of MIC/IITA [07-jeongcheck-06, A Research for Strategy of Standard Wireless internet Platform].

2. Description of the Related Art

In recent years, an electric powered vehicle has been rapidly developed in the vehicle industry due to problems, such as global warming caused by environmental disruption and high oil prices. Major automakers throughout the world are developing an electric powered vehicle as the new vehicle to be developed.

An electric powered vehicle has no exhaust gas and is advantageous in terms of low noise. The electric powered vehicle was manufactured in 1873 before a gasoline vehicle, but was not put to practical use due to problems, such as heavy weight of a storage battery and charging time. Meanwhile, due to the fact that environmental pollution is getting worse, the electric powered vehicle is once again being developed. However, since the capacity of a rechargeable storage battery is limited, there is a problem in that a vehicle cannot travel a long distance using only the secondary battery. For this reason, in recent years, a hybrid vehicle, which uses two power sources such as fossil fuel and a secondary battery, has been actively sold in the North American markets. PRIUS manufactured by Toyota Motor Corporation (Japan) is a typical example of a hybrid vehicle. PRIUS includes an engine that uses gasoline, a motor, and an alternator that can use a kinetic energy recovered during the braking of a vehicle as an electric energy.

Meanwhile, countermeasures where a rechargeable storage battery (that is, improving the performance of a secondary battery) and a fuel cell having characteristics different from an existing battery are used have been proposed in the case of an electric powered vehicle. Accordingly, existing problems, such as frequent charging and replacement of a secondary battery provided in an electric powered vehicle, are gradually being solved. Not electric powered vehicles for traveling on a common road but some small electric powered vehicles have already been commercialized and widely used. For example, the electric powered vehicle may be used as a golf cart, a vehicle for transporting players and sporting goods in a sports arena, a driving simulation vehicle, and an indoor cleaning vehicle. It is expected that the electric powered vehicle will soon be used as a common commercial vehicle and a passenger car.

A secondary battery provided in an electric powered vehicle should be periodically charged. In the related art, a method of data transmission using PLC, and an electric auto mobile and an electric charging equipment, which use the characteristics of an electric powered vehicle, was proposed in Korean Patent Application Publication No. 2007-0091762.

In the case of the electric charging equipment for an electric powered vehicle proposed in Korean Patent Application Publication No. 2007-0091762, electricity and data can be supplied using a powerline. Therefore, the electric charging equipment may facilitate the use of an electric powered vehicle, which may soon be commercialized, and a user can transmit various multimedia data required for a vehicle through a powerline.

In the case of the electric charging equipment for an electric powered vehicle proposed in the related art, a data signal, which is received through a powerline by a power line communication (hereinafter, referred to as ‘PLC’) technique, is transmitted to a data processing unit.

If an electric powered vehicle is widely distributed and commercialized, a secondary battery of the electric powered vehicle will be charged using a commercial power source outlet. For example, an electric charging station similar to current gas station appears, and people will charge the secondary battery of the electric powered vehicle by using a commercial power source outlet provided at the electric charging station. In this case, the commercial power source outlet may be a common commercial power source connecting means that is provided at home, a charging station dedicated to an electric powered vehicle, a parking lot of a building, and the like. Places where the commercial power source outlet is provided generally have the environment where it is difficult to perform data communication while charging the vehicle due to surrounding noise or mechanical noise. For example, if a charging station and a car wash are located at the same place, the noise or vibration of a motor that is driven to wash the vehicle in the car wash is considered to be a severe environment where it is difficult to reliably and effectively perform data communication while charging the vehicle due to surrounding noise or mechanical noise. Therefore, a communication technique, which can overcome high load interference, noise, signal distortion, and the like should be applied to reliably and effectively transmit data while charging the vehicle.

However, in the case of a PLC technique applied to the apparatus for charging an electric powered vehicle in the related art, it is difficult to effectively and reliably transmit a data signal under the above-mentioned environment due to potential noise of a powerline, high load interference, data signal distortion, and the like.

Further, in the case of the PLC technique, due to the potential noise of a powerline, it is difficult to develop an essential chip technique that improves communication quality, transmission speed, and communication range. Accordingly, there is a limitation on a range where communication can be performed (for example, 5 miles), so that high-output PLC amplifiers should be provided at intervals. For this reason, there is a drawback in that large start-up costs are required for an infrastructure, which becomes a pending issue in developing a technique hereafter.

Due to the above-mentioned reasons, it is not easy to reliably and effectively transmit data remotely by using the apparatus for charging an electric powered vehicle that uses the PLC technique in the related art. Further, there is a problem in that large costs are required to solve the above-mentioned problem.

### SUMMARY OF THE INVENTION

The present invention has been made to solve the above-mentioned problem, and it is an object of the present invention to provide an apparatus for charging an electric powered vehicle that can overcome potential noise of a powerline, high load interference, data signal distortion, and the like that occur when a data signal is transmitted while charging a vehicle by a PLC technique in the related art, and effectively and reliably transmit a data signal through a powerline while charging a vehicle. Further, it is another object of the present invention to provide an apparatus for charging an electric powered vehicle, which allows a user terminal to have access to various vehicle information terminals provided in a vehicle while charging a vehicle.

According to an aspect of the present invention, an apparatus for charging an electric powered vehicle includes a vehicle charging connector; an electrical power storage unit that is connected to the vehicle charging connector, receives electricity from the outside through a powerline, and stores the electricity; and a PAN (powerline area network) modem that is connected to the vehicle charging connector, connects the powerline with the vehicle information terminal, and transmits a data signal.

The apparatus may further include a storage unit that stores data including an identifier of a specific terminal. The PAN modem may transmit vehicle position information to the specific terminal on the basis of the identifier of the specific terminal.

The specific terminal may be a user terminal.

The PAN modem may receive the vehicle position information from the vehicle information terminal.

The apparatus may further include a storage unit that stores data transmitted through the powerline.

The apparatus may further include a vehicle-information terminal controller that is provided between the PAN modem and the vehicle information terminal. The vehicle-information terminal controller may control the vehicle information terminal on the basis of the data signal received from the PAN modem.

The vehicle-information terminal controller may be booted by a signal that is generated from the PAN modem.

The vehicle-information terminal controller may include a user authentication unit that authenticates a user.

Further, according to another aspect of the present invention, a PAN (powerline area network) communication method uses an apparatus for charging an electric powered vehicle. The method includes connecting the apparatus for charging an electric powered vehicle to a powerline, and receiving a data signal through the powerline; setting a communication path between a vehicle information terminal and a user terminal, which is connected to the vehicle information terminal through the powerline, on the basis of the data signal by a PAN modem provided in the apparatus for charging an electric powered vehicle; and performing communication between the vehicle information terminal and the user terminal through the powerline.

The performing of the communication may include transmitting vehicle position information to a specific terminal on the basis of an identifier of the predetermined specific terminal by the apparatus for charging an electric powered vehicle.

The specific terminal may be a user terminal.

The apparatus for charging an electric powered vehicle may receive the vehicle position information from the vehicle information terminal.

The performing of the communication may include authenticating a user.

According to the present invention, it is possible to overcome potential noise of a powerline, high load interference, data signal distortion, and the like that occur when a data signal is transmitted while charging a vehicle by a PLC technique in the related art, and to allow a user to effectively and reliably transmit a data signal to a vehicle information terminal through a powerline while charging a vehicle.

Further, according to the present invention, a user can find out the current position of one's own vehicle that is being charged. Accordingly, if user's own vehicle is stolen, a user can find out the position of the vehicle and retrieve the vehicle.

Furthermore, a user can store, move, and delete one's desired data of a vehicle information terminal remotely by a user terminal. If necessary, a user can receive and use desired data from data that is stored in various vehicle information terminals provided in a vehicle.

### BRIEF DESCRIPTION OF THE DRAWINGS

FIG. 1 is a view schematically illustrating a PAN (powerline area network) communication method using an apparatus for charging an electric powered vehicle according to an embodiment of the present invention;

FIG. 2 is a view illustrating the configuration of the apparatus for charging an electric powered vehicle according to the embodiment of the present invention;

FIG. 3 is a view illustrating the detailed configuration of a vehicle-information terminal controller of FIG. 2; and

FIG. 4 is a view illustrating the PAN communication method using the apparatus for charging an electric powered vehicle according to the embodiment of the present invention.

### DESCRIPTION OF THE PREFERRED EMBODIMENTS

An embodiment of the present invention will be described in detail below with reference to the accompanying drawings. Like reference numerals refer to like elements throughout this specification. Repeated description, and known functions and structure that may unnecessarily make a gist unclear will be omitted in this specification. Rather, these embodiments of the present invention are provided so that this disclosure will be thorough and complete and will fully convey the concept of the invention to those skilled in the art. Therefore, the shapes and sizes of components in drawings may be exaggerated for clearer description.

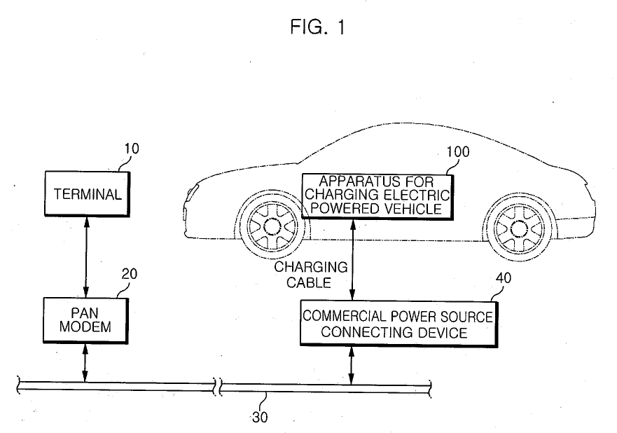

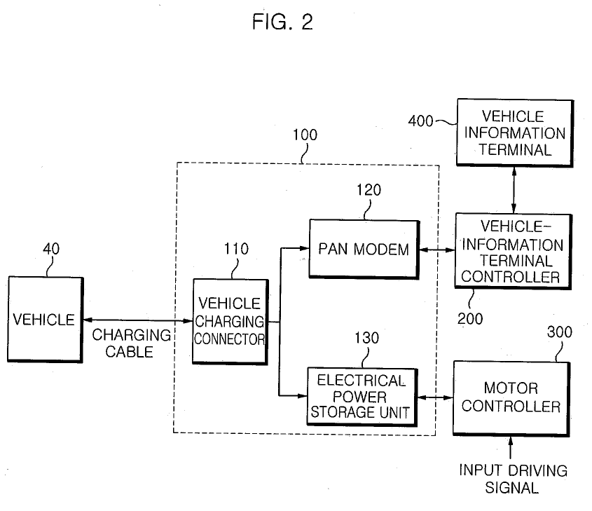

FIG. 1 is a view schematically illustrating a PAN (powerline area network) communication method using an apparatus for charging an electric powered vehicle according to an embodiment of the present invention, and FIG. 2 is a view illustrating the configuration of the apparatus for charging an electric powered vehicle according to the embodiment of the present invention;

Referring to FIGS. 1 and 2, an apparatus 100 for charging an electric powered vehicle according to an embodiment of the present invention is provided in an electric powered vehicle.

The apparatus 100 for charging an electric powered vehicle is connected to various vehicle information terminals 400 provided in an electric powered vehicle. Various vehicle information terminals 400 may be provided in the electric powered vehicle. For example, the vehicle information terminals 400 may include a navigation terminal, a convergence terminal, and a vehicle ECU (Electronic Control Unit). In this case, the vehicle ECU may not be suitable to be classified into a vehicle information terminal device, but will be described as the vehicle information terminal in the embodiment of the present invention.

After the electric powered vehicle travels a predetermined distance, a secondary battery is discharged. Therefore, the electric powered vehicle should be charged using a commercial power source connecting device 40. In this case, the commercial power source connecting device 40 may be a common commercial power source connecting means that is provided at home, a charging station dedicated to an electric powered vehicle, a parking lot of a building, and the like.

When the apparatus 100 for charging an electric powered vehicle according to the embodiment of the present invention is connected to the commercial power source connecting device 40 through a charging cable so as to be charged, the apparatus 100 for charging an electric powered vehicle is naturally connected to a powerline 30.

Further, a user terminal 10 is connected to the apparatus 100 for charging an electric powered vehicle according to the embodiment of the present invention through a PAN modem 20 and the powerline 30. In this case, the user terminal 10 may be a notebook computer, a desktop computer, a PDA, a cellular phone, or the like. The user terminal 10 and the PAN modem 20 have been separately formed in FIG. 1, but the PAN modem 20 may be integrated into the user terminal 10.

Meanwhile, a user can store, delete, and move data (for example, multimedia contents) stored in the vehicle information terminal 400 by the user terminal 10. For example, in the case of an electric powered vehicle provided with a GPS navigation terminal, it is possible to update map data, information about various regions, and the like, which are required for the GPS navigation terminal, after having remote access to the vehicle.

As another example, if an automaker provides access APIs (Application Programming Interfaces), such as units for engine start, light control, window control, air conditioner control, and automatic temperature control of a vehicle, it is possible to remotely and conveniently set various devices of a vehicle by the APIs. In this case, the various devices of the vehicle are included in the vehicle information terminals of the present invention.

An access program having a predetermined protocol, which is used to have access to a vehicle-information terminal controller 200 provided in a vehicle, is provided in a user terminal 10. Since basically having self-encoding and authentication protocols, the access program prevents hacking or access by an unauthenticated user. Further, the vehicle is provided with application programs based on various control APIs (Application Programming Interfaces) of a vehicle depending on the kind thereof, so that it is possible to control windows and lights, to start an engine, and adjust the air conditioner remotely.

The detailed functions of the apparatus 100 for charging an electric powered vehicle according to the embodiment of the present invention will be described with reference to FIG. 2.

First, the apparatus 100 for charging an electric powered vehicle according to the embodiment of the present invention includes a vehicle charging connector 110, a PAN modem 120, and an electrical power storage unit 130.

The vehicle charging connector 110 is connected to a commercial power source connecting device 40 through a charging cable. The vehicle charging connector 110 is a physical connector that is provided to charge the electric powered vehicle, and has arbitrary structure that is provided by an automaker. In general, the electrical power of single-phase 220V is required to charge the electric powered vehicle. The reason for this is to easily charge the electric powered vehicle. The electrical power applied to the vehicle charging connector 110 of the electric powered vehicle causes power to be transmitted to the electric powered vehicle through the electrical power storage unit 130 and a motor controller 300 of the electric powered vehicle.

The electrical power storage unit 130 rectifies the commercial AC power, which is applied to the vehicle charging connector 110 through the powerline 30, into direct current, and then stores the direct current. The electrical power storage unit 130 is generally composed of a large-capacity secondary battery.

The motor controller 300 drives a motor of the electric powered vehicle using the electrical power, which is stored in the electrical power storage unit 130, on the basis of a driving signal input by a driver. Since the motor of the electric powered vehicle is generally composed of an AC motor, the motor controller 300 is provided with an inverter.

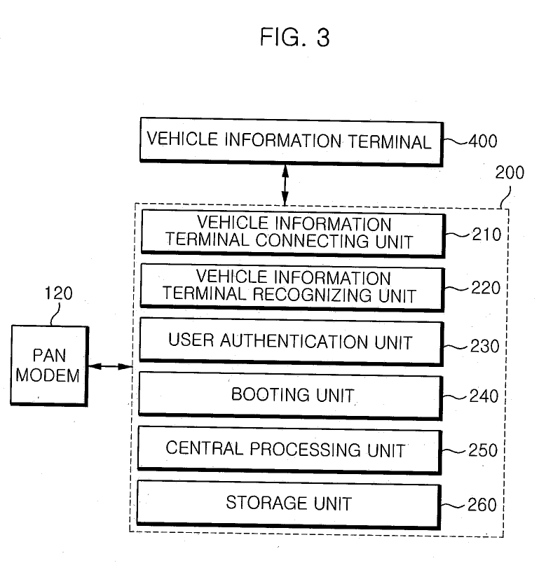

The PAN modem 120 connects the powerline 30 with the vehicle-information terminal controller 200, and transmits a data signal. In this case, the vehicle-information terminal controller 200 controls various vehicle information terminals 400, which is provided in the vehicle, on the basis of a data signal input from the PAN modem 120. The detailed functions and structure of the vehicle-information terminal controller 200 will be described in detail below with reference to FIG. 3.

Meanwhile, the vehicle-information terminal controller 200, and the PAN modem 120 and the vehicle information terminal 400 have been separately formed in FIG. 2, but the vehicle-information terminal controller 200 may be included in the PAN modem 120 or the vehicle information terminal 400. That is, if the vehicle-information terminal controller 200 is included in the vehicle information terminal 400, an ECU of each of the vehicle information terminals 400 may correspond to the vehicle-information terminal controller 200 of the embodiment of the present invention.

The PAN modem 120 may be provided to the electrical power storage unit 130 in parallel, and may be operated. The main structure and operation of the PAN modem will be described below. The PAN modem 120 is devised so as to transmit data through the powerline 30 by a powerline area network (hereinafter, referred to as a ‘PAN’) communication technique, and a commercialized physical chip (PHY) or logical chip (MAC) may be used as the PAN modem. The signal component of an electrical power signal input to the charging connector 110 is detected by the PAN modem 120. The detected signal component is generally converted into an Internet protocol (IP), and it is possible to have access to the vehicle-information terminal controller 200 by using the Internet protocol. Accordingly, a user secures a data channel by using the PAN modem 120, and can then transmit a data signal while charging the vehicle. Further, the user has access to the various vehicle information terminals 400 by the vehicle-information terminal controller 200, and can store, move, and delete user's desired data. The apparatus 100 for charging an electric powered vehicle according to the embodiment of the present invention can perform bidirectional communication by the PAN modem 120. Therefore, a user can have access to an external device (for example, the terminal 10) using the vehicle information terminal 400, and can then store, move, and delete user's desired data.

Meanwhile, the commercial power source connecting device 40 shown in FIG. 2 may be a common commercial power source connecting means that is provided at home, a charging station dedicated to an electric powered vehicle, a parking lot of a building, and the like. Places where the commercial power source connecting device 40 is provided generally have the environment (hereinafter, referred to as “severe environment”) where it is difficult to perform data communication while charging the vehicle due to surrounding noise or mechanical noise. For example, if a charging station and a car wash are located at the same place, the noise or vibration of a motor that is driven to wash the vehicle in the car wash are the severe environment where it is difficult to reliably and effectively perform data communication while charging the vehicle due to surrounding noise or mechanical noise. Therefore, a communication technique, which can overcome high load interference, noise, signal distortion, and the like, should be applied to reliably and effectively transmit data while charging the vehicle.

However, in the case of the PLC technique applied to an apparatus for charging an electric powered vehicle in the related art, it is difficult to reliably and effectively transmit data under the above-mentioned severe environment due to the potential noise of a powerline, high load interference, signal distortion, and the like.

In contrast, in the case of the PAN communication technique applied to the present invention, while passing through the powerline, a data signal is not mixed with other various signals and can be transmitted over a very long distance (for example, about 3200 Km) substantially at the speed of light without the playback of a separate signal. Further, as long as electrical power is provided, it is possible to perform super-high speed data communication even remotely. Further, while current flows, it is possible to perform bidirectional communication without a separate power. Therefore, the apparatus for charging an electric powered vehicle, to which the PAN technique is applied, according to the embodiment of the present invention can effectively and reliably transmit data using the powerline under the above-mentioned severe environment.

Further, when a data signal is transmitted using the apparatus for charging an electric powered vehicle in the related art, the data signal transmitted through the powerline does not pass through a transformer. For this reason, there is a limitation on the range where communication can be performed (for example, 8 km).

However, when a data signal is transmitted using the apparatus for charging an electric powered vehicle according to the embodiment of the present invention, the data signal transmitted through the powerline passes through a transformer. For this reason, the apparatus for charging an electric powered vehicle according to the embodiment of the present invention has a larger network applicable radius as compared to a method of transmitting data using a PLC technique in the related art. Therefore, a user can have remote access to the vehicle and transmit data without a limitation on a range where communication can be performed (for example, 8 km).

For the purpose of understanding the present invention, the PAN communication technique applied to the present invention and the PLC communication technique applied to the related art are compared with each other and the difference therebetween are summarized in Table 1.

TABLE 1

| | PAN communication | PLC communication |
|---|---|---|
| Applicable | WAN & LAN | Home networking |
| field | | |
| Communication | 2.5 Gbps to 200 Tbps | 1 to 10 Mbps |
| speed | | |
| Application | Communication using a | Communication |
| | magnetic field generated | using a powerline |
| | around a powerline | |
| Range | 2000 mile (3,200 Km) | 5 mile (8 Km) |
| Bandwidth | Unlimited (20 GHz~24,000 | Narrow band |
| | GHz) | |
| Simplicity | Cluster controller (for | router, repeater |
| | managing a path) | (for amplifying a |
| | | signal) |
| Problems | A problem where a signal | A problem where a |
| | does not pass through a | signal does not |
| | transformer is solved | pass through a |
| | | transformer is not |
| | | solved-detour |

In general, a wireless access method may be used to perform remote control of contents and information terminal devices provided in a vehicle. However, if the present invention is used, a user does not need to perform complicated wireless setting processes that are required for the wireless access. Further, it can be seen that wireless access has no limitation on a space. Therefore, a separate data communication cable does not need to be connected to the vehicle and the data communication, and there is an advantage in that an expensive wire infrastructure for telecommunication is not required.

Meanwhile, contents or firmware of systems can be updated by a memory card, a potable storage device, or the like. However, since a memory device should be frequently attached and detached in this case, a user may be inconvenient in terms of the accessibility to a vehicle. Therefore, the present invention has an advantage of solving the inconvenience.

FIG. 3 is a view illustrating the detailed configuration of a vehicle-information terminal controller 200 of FIG. 2.

The vehicle information terminal controller 200 applied to the electric powered vehicle according to an embodiment of the present invention includes a vehicle information terminal connecting unit 210, a vehicle information terminal recognizing unit 220, a user authentication unit 230, a booting unit 240, a central processing unit 250, and a storage unit 260.

The vehicle information terminal connecting unit 210 sets a communication path to the vehicle information terminal 400, controls data transmission, and checks a communication state, thereby making the communication be stable.

For the purpose of smooth data communication between the PAN modem 120 and a vehicle information terminal 400 mounted on the vehicle, the vehicle information terminal recognizing unit 220 recognizes the vehicle information terminal 400, and sets an environment required for communication or installs more environments.

The user authentication unit 230 performs user authentication for the purpose of security. The user authentication unit 230 receives information including a user ID from a user, and authenticates a user to determine whether the user can join a session for data transmission. However, a user authentication method is not limited thereto, and various user authentication methods known in the related art may be used to determine whether a user is authorized.

The booting unit 240 receives a signal generated from the PAN modem 120, causes self wake-up interrupt, and performs a booting process. In this case, when the charging cable is connected to the vehicle charging connector 110, the signal to be generated from the PAN modem 120 is generated. When the booting is completed, a user can have remote access to the vehicle information terminal 400 by the user terminal 10. When the booting is completed by the booting unit 240 and the vehicle information terminal controller is in a stand-by state, a user freely has access to the vehicle information terminal 400 even remotely and can control the vehicle information terminal 400 by a terminal. For example, a user can delete and move the data stored in the vehicle information terminal 400.

Typical examples of the vehicle information terminal 400 may include a navigation terminal that provides GIS (Global information System) information to help a person to smoothly drive a vehicle, a convergence terminal that plays back multimedia contents, such as an image, sound, and a digital picture, and a vehicle ECU that is a particular electronic control unit of a vehicle.

The central processing unit 250 control the operation of each of the parts so that data transmitted through the powerline is stored in the storage unit 260. Further, the central processing unit 250 controls the operation of the PAN modem 120 and each part, and allows a user to have access to the vehicle information terminal 400 by the user terminal and to control the desired vehicle information terminal 400 (for example, to delete, move, and store the data). For this purpose, the central processing unit 250 basically includes an instruction interpreter, which interprets instruction when the instruction is transmitted to control the vehicle information terminal 400. Further, when a user requests data stored in the storage unit 260 by the vehicle information terminal 400, the central processing unit 250 extracts the data stored in the storage unit 260 and provides the data to the vehicle information terminal 400 according to the user's input. When the booting is completed by the booting unit 240 and the vehicle information terminal controller is in a stand-by state, the central processing unit 250 collects information about the current position of a vehicle, and periodically or aperiodically transmits the information to a predetermined specific terminal through the PAN modem 120. In this case, generally, the specific terminal may be the user terminal 10. The user terminal 10 receives vehicle position information from the PAN modem 120, and displays the current position of the vehicle, which is being charged, on a display provided in the user terminal 10. Meanwhile, the specific terminal may also include a server terminal. In this case, the server terminal receives the vehicle position information from the PAN modem 120, and stores the position information. Accordingly, a user can have access to the server terminal by the user terminal 10 if necessary, and can find out the position of the vehicle by using the vehicle position information that is stored in the server terminal. Therefore, even though the user terminal 10 is turned off and the PAN modem 120 thus cannot transmit the vehicle position information to the user terminal 10, it is possible to find out the position of the vehicle by the vehicle position information stored in the server terminal.

For example, the central processing unit 250 receives current vehicle position information (for example, position coordinates) from the navigation terminal that provides GIS information, and then transmits the current vehicle position information to a specific terminal (for example, predetermined user terminal) through the powerline 30. For this purpose, an identifier (for example, IP address) of the specific terminal is basically stored in the storage unit 260. In this case, the identifier of the specific terminal may be stored in the PAN modem 120, and the PAN modem 120 basically includes a memory for this purpose. As another example, assuming that the commercial power source connecting device 40 has a particular code used to identify a current position, the central processing unit 250 receives the code from the commercial power source connecting device 40, and can find out the current position of the vehicle on the basis of the code. The current position of the vehicle may be found out using various methods that can be derived from this specification by those skilled in the art.

As described above, when the apparatus 100 for charging an electric powered vehicle according to the embodiment of the present invention is connected to the commercial power source connecting device 40, that is, when the vehicle is being charged, a user can find out the current position of the vehicle by using one's own terminal 10. According to the present invention, a user can find out the current position of one's own vehicle that is being charged. Accordingly, if user's own vehicle is stolen, a user can find out the position of the vehicle and retrieve the vehicle. The electric powered vehicle should be periodically charged due to the power characteristic.

As an application, if a stolen user's vehicle is being charged, a user can control the motor controller 300 by the vehicle-information terminal controller 200 so that the driving of the electric powered vehicle is stopped. In this case, the motor controller 300 corresponds to the vehicle information terminal in the present invention. Therefore, the user can quickly retrieve the stolen one's vehicle.

In addition, the central processing unit 250 periodically checks the information about the vehicle (for example, the state of a vehicle), and transmits the information to the user terminal 10 through the powerline 30. Therefore, a user can grasp the current state of the vehicle remotely.

The storage unit 260 stores the data transmitted through the powerline according to the control of the central processing unit 250. Necessary data is extracted from the data stored in the storage unit 260 according to the control signal of the central processing unit 250, and is then provided to the vehicle information terminal 400 or the user terminal 10.

Meanwhile, the storage unit 260 has been described to be included in the vehicle-information terminal controller 200 in the apparatus 100 for charging an electric powered vehicle according to the embodiment of the present invention. However, the vehicle-information terminal controller 200 may be separated from the storage unit 260. If the vehicle-information terminal controller 200 is separated from the storage unit 260, the vehicle information terminal 400 may be separately connected to the vehicle-information terminal controller 200 and the storage unit 260. The reason for this is to directly have access to the storage unit 260 without passing through the vehicle-information terminal controller 200 when the vehicle-information terminal controller 200 is in the stand-by state, or when the vehicle information terminal 400 uses only the data stored in the storage unit 260.

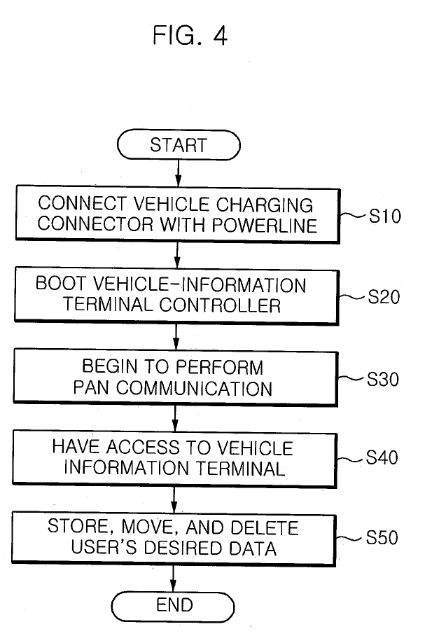

FIG. 4 is a view illustrating a method of having remote access to the vehicle information terminal using a powerline area network communication technique according to the embodiment of the present invention.

When the charging cable connected to the commercial power source connecting device 40 is connected to the apparatus 100 for charging an electric powered vehicle provided in the electric powered vehicle for the purpose of charging, the apparatus 100 for charging an electric powered vehicle is connected to a powerline 104 (S10). In this case, the commercial power source connecting device 40 may be a common commercial power source connecting means that is provided at home, a charging station dedicated to an electric powered vehicle, a parking lot of a building, and the like. When the apparatus 100 for charging an electric powered vehicle is connected to the powerline 104, the PAN modem 120 outputs a signal for performing a booting process to the vehicle-information terminal controller 200. Accordingly, the vehicle-information terminal controller 200 receives a signal generated from the PAN modem 120, causes self wake-up interrupt, and performs a booting process (S20). Then, the vehicle-information terminal controller receives information about the data signal, which is to be transmitted to the apparatus 100 for charging an electric powered vehicle, from the user. The data signal, which is received from the user, is transmitted to the apparatus 100 for charging an electric powered vehicle through the powerline 30. The apparatus 100 for charging an electric powered vehicle sets a communication path between the user terminal and the vehicle information terminal on the basis of the data transmitted through the powerline 30, and a powerline area network communication begins to be performed between the user terminal 10 and the vehicle information terminal 400 (S30). In this case, the vehicle-information terminal controller 200 receives current vehicle position information from the vehicle information terminal, which provides GIS information, and then transmits the position information to a specific terminal (for example, user terminal) by the powerline area network. Accordingly, a user can find out the position of one's own vehicle that is being charged. Therefore, if user's own vehicle is stolen, a user can find out the position of the vehicle and retrieve the vehicle. Further, a user has remote access to the vehicle information terminal 400 through the user terminal 10, and can perform control (for example, delete, move, and store the data) (S40 and S50). Furthermore, since being capable of performing bidirectional communication through the PAN modem 120, a user can have access to an external terminal by using the vehicle information terminal 400 and can then store, move, and delete desired data.

Meanwhile, a method of having remote access to the vehicle information terminal using a PAN communication technique according to the embodiment of the present invention may have many applications depending on the information that is requested by a user in the electric powered vehicle. For example, the method according to the embodiment of the present invention has a larger network applicable radius and higher communication speed as compared to a method of transmitting data using a PLC technique in the related art. Therefore, a user of an electric powered vehicle can have access to the Internet at a charging station, and can obtain and use desired information.

It was not possible to charge a hybrid vehicle using an existing nickel hydride secondary battery by a common commercial power source connecting unit. In recent years, a plug-in hybrid vehicle, which uses a lithium-ion secondary battery and can be charged using a common commercial power source, has been developed to solve this problem. As for the plug-in hybrid vehicle, the following has been known. That is, if being charged for 3 hours, the plug-in hybrid vehicle can travel about 13 Km during a test drive.

The plug-in hybrid vehicle also corresponds to an electric circuit, which is equivalent to a simple electric powered vehicle, during the above-mentioned charging process. Therefore, the electric powered vehicle has been mainly described for the purpose of effective description of the present invention, but it is apparent to persons having an electrical technique that the present invention can also be applied to a plug-in hybrid vehicle.

Although the preferred embodiments of the present invention have been disclosed above for illustrative purposes, the present invention is not limited to the above-mentioned specific embodiments. Further, those skilled in the art will appreciate that various modifications, additions and substitutions are possible, without departing from the scope and spirit of the invention as disclosed in the accompanying claims. These modifications should not be understood independently of the scope and spirit of the invention.

What is claimed is:

1. An apparatus for charging an electric powered vehicle, the apparatus comprising:
a vehicle charging connector;
an electrical power storage unit that is connected to the vehicle charging connector, receives electricity from the outside through a powerline, and stores the electricity; and
a PAN (powerline area network) modem that is connected to the vehicle charging connector, connects the powerline with a vehicle information terminal, and transmits a data signal.

2. The apparatus according to claim 1, further comprising:
a storage unit that stores data including an identifier of a specific terminal,
wherein the PAN modem transmits vehicle position information to the specific terminal on the basis of the identifier of the specific terminal.

3. The apparatus according to claim 2,
wherein the specific terminal is a user terminal.

4. The apparatus according to claim 2,
wherein the PAN modem receives the vehicle position information from the vehicle information terminal.

5. The apparatus according to claim 1, further comprising:
a storage unit that stores data transmitted through the powerline.

6. The apparatus according to claim 1, further comprising:
a vehicle-information terminal controller that is provided between the PAN modem and the vehicle information terminal,
wherein the vehicle-information terminal controller controls the vehicle information terminal on the basis of the data signal received from the PAN modem.

7. The apparatus according to claim 6,
wherein the vehicle-information terminal controller is booted by a signal that is generated from the PAN modem.

8. The apparatus according to claim 6,
wherein the vehicle-information terminal controller includes a user authentication unit that authenticates a user.

9. A PAN (powerline area network) communication method using an apparatus for charging an electric powered vehicle, the method comprising:
connecting the apparatus for charging an electric powered vehicle to a powerline, and receiving a data signal through the powerline;
setting a communication path between a vehicle information terminal and a user terminal, which is connected to the vehicle information terminal through the powerline, on the basis of the data signal by the apparatus for charging an electric powered vehicle; and
performing communication with the vehicle information terminal by the apparatus for charging an electric powered vehicle.

10. The method according to claim 9,
wherein the performing of the communication includes transmitting vehicle position information to a specific terminal on the basis of an identifier of the predetermined specific terminal by the apparatus for charging an electric powered vehicle.

11. The method according to claim 10,
wherein the specific terminal is a user terminal.

12. The method according to claim 10,
wherein the apparatus for charging an electric powered vehicle receives the vehicle position information from the vehicle information terminal.

13. The method according to claim 9,
wherein the performing of the communication includes transmitting the user authentication information that is received from the user terminal to the vehicle information terminal.
